(19) United States
(12) Patent Application Publication
(10) Pub. No.: US 2007/0037612 A1
(43) Pub. Date: Feb. 15, 2007

(54) Digital television with built-in telephone function

(75) Inventor: Joung-ho Roh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/366,506

(22) Filed: Mar. 3, 2006

(30) Foreign Application Priority Data
Jul. 21, 2005 (KR) 2005-0066241

(51) Int. Cl. H04M 1/00

(52) U.S. Cl. 455/575.1; 379/211.02

(57) ABSTRACT

A digital television with a built-in telephone function and a call transmitting and receiving method are provided as a user interface. The digital television includes a telephone module for receiving information including calls, text messages, and fax data. A remote control with a telephone handset function transmits a signal to the telephone module. A transmitting and receiving device performs transmission and receiving of audio data between the telephone module and the remote control. A memory stores multimedia information including audio data. A controller connects an incoming call signal transmitted from the remote control to the telephone module through the transmitting and receiving device, thereby allowing a user to place or receive a call. Accordingly, a user's convenience is maximized with the digital television functioning as a low-cost telephone that includes multimedia materials and an address list stored in the memory, which can be seen on a screen of the TV.

### CROSS-REFERENCE TO RELATED APPLICATIONS

This application claims the benefit under 35 U.S.C. §119(a) of Korean Patent Application No. 2005-66241, filed on Jul. 21, 2005, in the Korean Intellectual Property Office, the entire disclosure of which is hereby incorporated by reference.

### BACKGROUND OF THE INVENTION

1. Field of the Invention

The present invention relates in general to a digital television. More particularly, the present invention relates to a digital television with a built-in telephone function and a call transmitting and receiving method.

2. Description of the Related Art

A multifunction telephone, such as a caller identification (ID) phone providing caller identification information of a calling party, has grown in popularity. Despite the convenience of wired telephones, people prefer and are accustomed to the convenience of cellular phones. The number of people using a wired phone with diverse functions adapted to suit different tastes has been reduced continuously. Many people now use cellular phones at their residence, while the wired phones are used as a supplemental communication device. For this reason, low-cost telephones with basic functions are now preferred.

As an attempt to solve the above-described problem, a display device, for example, a television (TV), having a telephone function has been developed to provide a user with a low-cost telephone.

FIG. 1 illustrates an example of a conventional TV with a caller ID display function. As shown in FIG. 1, the TV includes a tuner 10 for tuning to a channel broadcast signal among signals received through an antenna; a video circuit unit 20 for transferring a broadcast signal provided through the tuner 10 to a rear end; a microprocessor (MCU) 60 for outputting a signal for the control of overall operations of the TV, including the video circuit unit 20; a caller ID signal detection module 70 for detecting a telephone number of a caller from an incoming signal input to the telephone through an external telephone line and providing corresponding information to the microprocessor; a memory 50 for storing caller information provided through the caller ID signal detection module 70 and icon information under the control of the microprocessor 60; an On Screen Display (OSD) generator 30 for generating and outputting an OSD signal for the corresponding caller information which is read from the memory 50 under the control of the microprocessor 60; and a mixer 40 for mixing television broadcast video signals output from the video circuit unit 20 with the OSD signal provided from the OSD generator 30, and displaying the resulting signals on a cathode ray tube.

To view information on a caller ID display device, when an incoming signal from an external telephone line is detected through an IN line of the caller ID detection module, the caller ID display device first checks whether the TV is turned on. If the TV is turned on, the caller ID display device checks whether the caller's phone number is stored. If the caller's phone number is stored, other information relating to the caller is loaded and displayed in the form of OSD text, along with the caller's phone number, on the display device, such as, the TV screen. However, if the caller's phone number is not stored, only the caller's phone number is output and displayed on the display device.

If the user is not available, the microprocessor 60 stores the information such as callers' phone numbers and time of each incoming call in the memory 50 according to conditions the user has set. Therefore, when the user becomes available and turns on the TV, the callers' phone numbers and time of each incoming call are output in the form of OSD text on the screen.

A deficiency exists in the conventional TV with caller ID display function. The TV displays only the caller information for an incoming call while the user is watching TV, and cannot deliver voice messages or text messages from callers.

Therefore, it is necessary to develop an integrated TV-phone device capable of storing multimedia data transmitted to or received from a telephone in a memory built in a digital TV.

### SUMMARY OF THE INVENTION

An aspect of exemplary embodiments of the present invention is to address at least the above problems and/or disadvantages and to provide at least the advantages described below. Accordingly, an aspect of embodiments of the present invention is to provide a display device with a built-in telephone function, capable of editing and transmitting data, such as, telephone directory information, text messages and other multimedia, while viewing the data on a large (television) screen.

To achieve the above objects and advantages of exemplary embodiments of the present invention, there is provided a display device with a telephone function, whereby a telephone module receives information including calls, text messages, and fax data. A remote control with a telephone handset function transmits a signal to the telephone module. A transmitting and receiving device transmits and receives audio data between the telephone module and the remote control. A memory stores multimedia information including audio data. A controller connects an incoming call signal transmitted from the remote control to the telephone module through the transmitting and receiving device, thereby allowing a user to place or receive a call, and reads stored multimedia information received at the telephone module in the memory.

In an exemplary embodiment of the present invention, the memory stores caller information and other data information provided from the telephone module, callers' phone numbers and history, memos or messages connected with the callers' phone numbers, count of calls and an amount of time answering calls, personal information of callers, and a function for rejecting calls from unwanted callers.

In an exemplary embodiment of the present invention, the remote control has number keys through which the user directly dials a desired phone number or generates an outgoing call using a menu stored in the memory, and the controller enables the user to edit the menu in the memory and restore the edited menu in the memory.

For example, the audio data is stored in the memory in a compressed format.

In an exemplary embodiment of the present invention, the remote control includes an infrared (IR) transmitting and receiving unit for performing an input and output operation for a command. A radio frequency (RF) communication unit for transmitting and receiving audio data.

Another aspect of an exemplary embodiment of the present invention provides a display device with a telephone function, whereby a telephone module receives information including calls, text messages, and fax data. A memory stores multimedia information including audio data received at the telephone module. A controller connects an external telephone line to the telephone module, thereby allowing a user to place or receive a call, and reads stored multimedia information received at the telephone module in the memory.

In an exemplary embodiment of the present invention, the memory stores in the form of a menu, caller information and other data information provided from the telephone module, callers' phone numbers and history, memos or messages connected with the callers' phone numbers, count of calls and an amount of time answering calls, personal information of callers, a function for rejecting calls from unwanted callers.

In an exemplary embodiment of the present invention, the controller enables the user to directly dial a desired phone number using number keys or generate an outgoing call using a menu stored in the memory, and edit the menu in the memory and restore the edited menu in the memory.

For example, the audio data is stored in the memory in a compressed format.

Still another aspect of an exemplary embodiment of the present invention provides a call transmitting and receiving method for a display device equipped with a remote control and a telephone module for transmitting and receiving audio data, and a memory for storing caller information and multimedia information, whereby multimedia information is received including audio data or an incoming call through the telephone module. Communication is made through the remote control and the telephone module when the incoming call is received.

For example, when the multimedia information is received the information is stored in the memory under the control of a controller.

In an exemplary embodiment of the present invention, the memory stores, in the form of a menu, caller information and other data information provided from the telephone module, callers' phone numbers and history, memos or messages connected with the callers' phone numbers, count of calls and an amount of time answering calls, personal information of callers, and a function for rejecting calls from unwanted callers.

In an exemplary embodiment of the present invention, the communication includes notifying of the incoming call signal through the display device. The memory is searched for caller information connected with the incoming call signal and the information is displayed. The user is enabled to receive the call through the remote control and the telephone module, if a user determines to receive the call from the displayed caller information.

For example, the audio data is stored in the memory in a compressed format.

Yet another aspect of an exemplary embodiment of the present invention provides a call transmitting and receiving method for a display device equipped with a remote control and a telephone module for transmitting and receiving audio data, and a memory for storing caller information and multimedia information, whereby a user is allowed to dial a phone number directly from the remote control, or generate an outgoing call using the caller information stored in the memory. The user is allowed to communicate through the remote control and the telephone module, when the call is answered.

In an exemplary embodiment of the present invention, the caller information contains data information provided from the telephone module, callers' phone numbers and history, memos or messages connected with the callers' phone numbers, count of calls and an amount of time answering calls, personal information of callers, and a function for rejecting calls from unwanted callers.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic diagram illustrating a conventional TV with a caller ID display function;

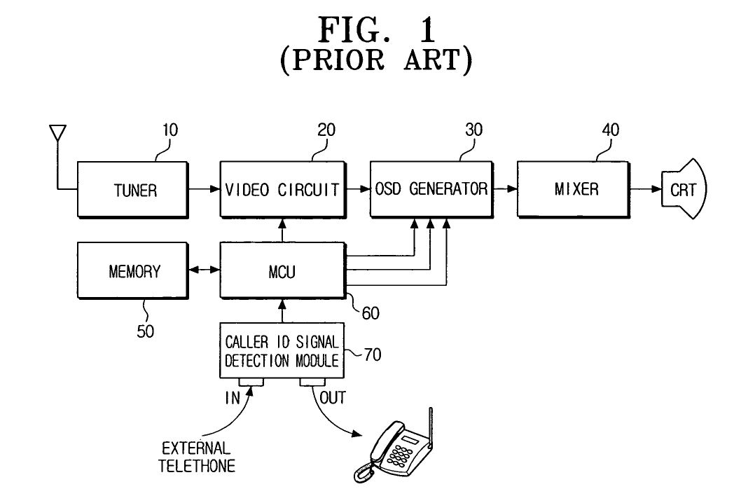

FIG. 2 is a schematic block diagram of a display device with a telephone function, according to an exemplary embodiment of the present invention; and

FIG. 3 is a flow chart explaining a procedure of placing or receiving a phone call, according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

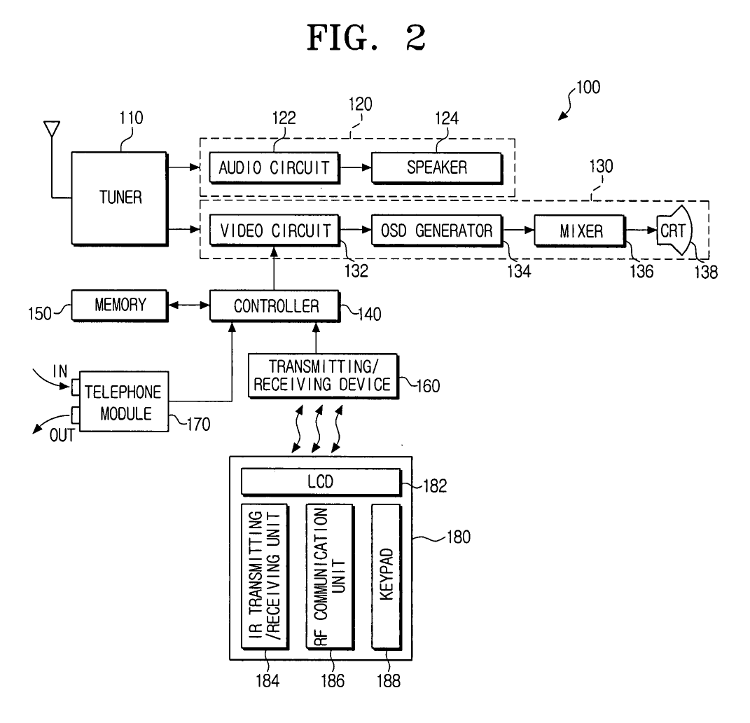

FIG. 2 is a schematic block diagram of a display device with a telephone function, according to an exemplary embodiment of the present invention. The display device 100 with a telephone function includes a tuner 110, audio signal processing unit 120, video signal processing unit 130, controller 140, memory 150, transmitting/receiving device 160, telephone module 170, and remote control 180.

The tuner 100 tunes to a desired channel broadcast signal among signals received through an antenna, separates the broadcast signal into an audio signal and a video signal, and outputs the audio and video signal to the audio signal processing unit 120 and video signal processing unit 130, respectively.

The audio signal processing unit 120 includes an audio circuit 122 processing the audio signal provided from the tuner 100, and a speaker 124 outputting the processed audio signal from the audio circuit 122 as audible sound outside the display device.

The video signal processing unit 130 includes a video circuit 132 processing the video signal provided from the tuner 100, OSD generator 134 for generating and outputting an OSD signal containing a caller's phone number read from the memory 150, and mixer 136 for mixing a television broadcast video signal output from the video circuit 122 with an OSD signal provided from the OSD generator 134 and displaying the resulting signals on a cathode ray tube 138. Since the following exemplary embodiments of the present invention provide information using the OSD, a conventional electronic program guide (EPG) may also be used to display information.

The telephone module 170 is capable of receiving and transmitting audio data. For example, the telephone module 170 provides the controller 140 with an incoming signal input to a telephone through an external telephone line, a caller's phone number contained in the incoming signal, and/or fax data if a fax is received. If necessary, the telephone module 170 originates (or generates) an outgoing call to a telephone number transmitted from the controller 140.

The memory 150 stores caller information and other data information (including fax data) provided from the telephone module 170. The memory 150 may store a menu including callers' phone numbers, history, memos or messages connected with the callers' phone numbers, count of calls and an amount of time answering calls or conversing on a phone, personal information relating to callers, function for rejecting calls from unwanted callers, and the like. In addition, contents of a conversation or audio data (messages) of another party, recorded during the user's absence, can be compressed into low capacity data, similar to compression in MP3 or other compression systems, by using an application of a program or an audio decoding chip (not shown) to be stored in the memory. The data may be reproduced, edited and transmitted by a user.

The remote control 180 serves to receive and transmit audio data for communication with the display device 100. The remote control 180 includes a keypad 188 for allowing the user (or viewer) to operate the display device 100 or input a telephone number by selecting a telephone number input mode; an infrared (IR) transmitting/receiving unit 184 for controlling the display device 100 or performing an input/output operation for a command; a radio frequency (RF) communication unit 186 for transmitting and receiving audio data; and a liquid crystal display (LCD) 182 for displaying a state of the remote control 180. The keypad 188 allows the user to dial and operate a TV control key at the same time by pressing a delete key for deleting telephone numbers that have been registered, directional keys for moving a cursor on the screen of a CRT, enter key for selecting an item pointed by the cursor, and the like.

The transmitting/receiving device 160 processes data that is transmitted and received between the IR transmitting/receiving unit 184 and the RF communication unit 186 of the remote control 180, and sends the processed data to the controller 140.

The controller 140 outputs signals for controlling the overall operations of the display device 100. For example, the controller 140 controls the CRT 138 to display the operational state of the remote control 180 or controls the OSD generator 134 to display various menus used for inputting and searching telephone numbers. Moreover, the controller 140 controls the display device 100 to be able to read a menu from the memory 150, and display or edit the menu as needed. For audio data, under the control of the controller 140, content of a conversation or audio data (messages) of another party (that is, the caller) recorded during the user's absence can be converted into a compressed format of low capacity data, similar to the compressed format in MP3 or other compression systems, and stored in the memory 150, so that the data can be reproduced, edited and transmitted by the user.

For video data (for example, a document) received from the telephone module 170, the controller 140 compresses or decodes the document by using a fax function, whereby the user can check the document on the screen of the CRT 138 through a preview function, and output the data using a peripheral connected with the display device 100.

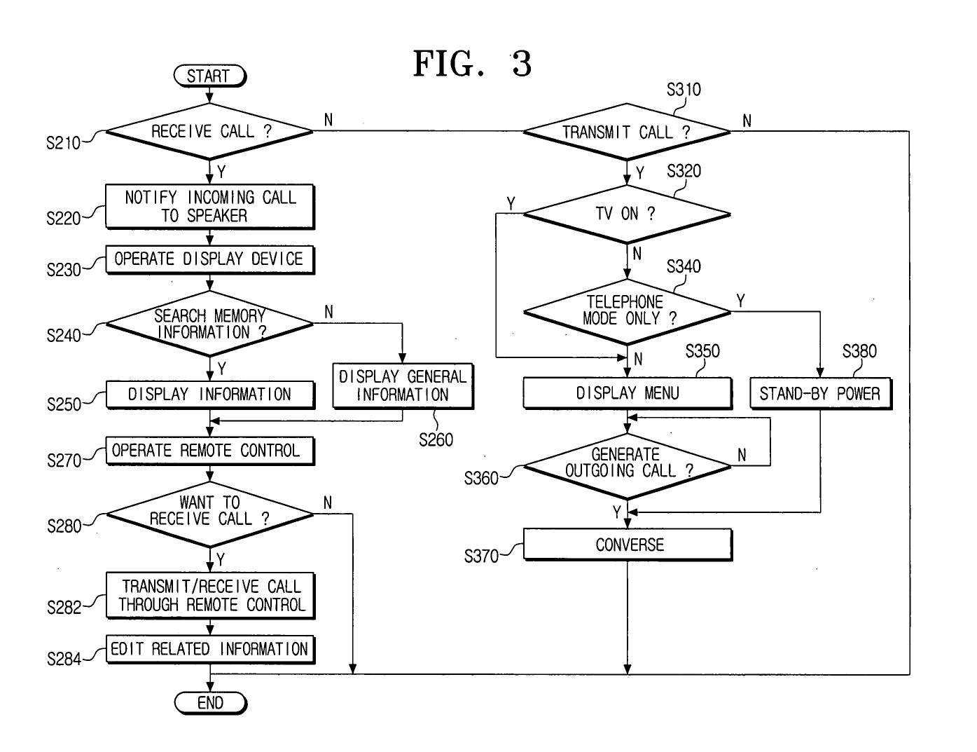

With reference to FIG. 3, a description will be made below on how to place or receive a phone call using the display device of an exemplary embodiment of the present invention.

When an incoming signal is detected through the IN line of the telephone module 170 from an external telephone line (S210), the controller 140 notifies through the speaker 124 of the call received (S220). Once notification of the call is made through the speaker, the display device 100 is operated. The display device 100 is fed with stand-by power. If the stand-by power is fed to the display device 100, the controller 140 supplies a secondary power to the display device 100 to run the CRT 138 (S230).

The controller 140 then searches the memory 150 for a caller information using the telephone number of a caller (S240), and filters or displays the caller information on the menu screen which includes history, memos or messages connected with the caller, count of calls and an amount of time answering calls or conversing on a phone, personal information of the caller, a function for rejecting calls from unwanted callers, and the like. (S250). If the corresponding caller information is not stored in the memory 150, then general information relating to the caller is displayed (S260).

Referring to the displayed information, the user operates the keypad 188 of the remote control 180 (S270), and determines whether to receive the call. Then, the user sends a determination result to the transmitting/receiving device 160 through the IR transmitting/receiving unit 184 (S280).

If the user receives the call, the controller 140 connects the telephone module 170 to the transmitting/receiving device 160 so that audio data may be transmitted and received through the RF communication unit 186 of the remote control 180 (S282).

The user may edit the data related to the caller information by operating the remote control 180, and restore the edited data in the memory 150 (S284).

When the user inputs a call transmission mode through the remote control 180 (S310), the controller 140 checks the power supply state of the display device 100. That is, the controller 140 determines whether the TV is turned on (S320). If the display device 100 is turned on (S320) the controller 140 immediately switches the display device 100 into the telephone mode for the user. However, if the display device 100 is turned off the controller 140 determines whether the user wants to use only the telephone function built in the TV (S340). If the user wants to use the telephone function, the controller 140 allows the user to communicate (S370) in stand-by power (S380).

In step 340, instead of inputting the telephone mode, if the user wants to make a phone call using the display device 100, the controller 140 operates the menu using the OSD generator 134, reads the data stored in the memory 150, and displays the telephone directory or stored messages on the CRT 138 (S350).

The user then has the ability to choose an address in the telephone directory by using the directional keys on the keypad 188 of the remote control 180, or select a person he or she wants to call by directly pressing the number keys on the remote control 180 (S360). Then the controller 140 controls the telephone module 170 to generate an outgoing call to the corresponding telephone number (S370).

If the remote control 180 has a telephone handset function, transmitting and receiving audio data between the transmitting/receiving device 160 and the telephone module 170 may be implemented through the RF communication unit 186.

Therefore, the display device (that is, a digital TV) with a built-in telephone function allows the user to directly input a telephone number he or she wants to call, and can store/manage all data that is transmitted and received through the telephone module 170. Accordingly, the display device and functions of a telephone can be incorporated to maximize the user's convenience.

Although exemplary embodiments of the present invention illustrate a remote control having the telephone function, that is, placing or receiving phone calls, a speaker phone function can also be incorporated into the display unit. Moreover, by setting the display unit to the speaker phone function and designing the remote control to function as a memo device or another device with additional functions, the user's convenience may be increased more.

As described above, the digital television with a built-in telephone function can be advantageously used as a user interface by integrating a telephone function with a storage function and other additional functions of the memory and the controller of an existing digital TV. Therefore, the confined and limited display space of the telephone (for example, a caller ID phone) can be overcome by using a large-screen TV. Multimedia materials and an address list stored in the memory can be conveniently used as an interface in the form of a big screen TV.

Moreover, the user's convenience can be increased by incorporating the speaker phone function of the telephone into the display device, while using a remote control as a memory device or another device with additional functions.

Since audio and other additional data are compressed and stored in the memory of the digital TV, the data storage efficiency is maximized.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A display device with a telephone function, comprising:
a telephone module for receiving information comprising calls, text messages, and fax data;
a remote control with a telephone handset function for transmitting a signal to the telephone module;
a transmitting and receiving device for transmitting and receiving audio data between the telephone module and the remote control;
a memory for storing multimedia information including audio data; and
a controller for connecting an incoming call signal transmitted from the remote control to the telephone module through the transmitting and receiving device, thereby allowing a user to place or receive a call, and reading stored multimedia information received at the telephone module in the memory.

2. The display device of claim 1, wherein the memory stores caller information and other data information provided from the telephone module, callers' phone numbers and history, memos or messages connected with the callers' phone numbers, count of calls and an amount of time answering calls, personal information of callers, and a function for rejecting calls from unwanted callers.

3. The display device of claim 2, wherein the remote control has number keys in which the user directly dials a phone number or generates an outgoing call using a menu stored in the memory.

4. The display device of claim 2, wherein the controller enables the user to edit the menu in the memory and restore the edited menu in the memory.

5. The display device of claim 2, wherein the audio data is stored in the memory in a compressed format.

6. The display device of claim 3, wherein the remote control comprises:
an infrared (IR) transmitting and receiving unit for performing an input and output operation for a command; and
a radio frequency (RF) communication unit for transmitting and receiving audio data.

7. A display device with a telephone function, comprising:
a telephone module for receiving information comprising calls, text messages, and fax data;
a memory for storing multimedia information comprising audio data received at the telephone module; and
a controller for connecting an external telephone line to the telephone module, thereby allowing a user to place or receive a call, and reading stored multimedia information received at the telephone module in the memory.

8. The display device of claim 7, wherein the memory stores in the form of a menu caller information and other data information provided from the telephone module, callers' phone numbers and history, memos or messages connected with the callers' phone numbers, count of calls and an amount of time answering calls, personal information of callers, and a function for rejecting calls from unwanted callers.

9. The display device of claim 8, wherein the controller enables the user to directly dial a phone number using number keys or generate an outgoing call using a menu stored in the memory.

10. The display device of claim 8, wherein the controller enables the user to edit the menu in the memory and restore the edited menu in the memory.

11. The display device of claim 8, wherein the audio data is stored in the memory in a compressed format.

12. A call transmitting and receiving method for a display device comprising a remote control for transmitting and receiving audio data, telephone module, and memory for storing caller information and multimedia information, the method comprising:
receiving multimedia information including audio data or an incoming call through the telephone module; and
communicating through the remote control and the telephone module when the incoming call is received.

13. The method of claim 12 further comprising:
storing the information in the memory under the control of a controller, when the multimedia information is received in the information receiving step.

14. The method of claim 12, wherein the memory stores in the form of a menu caller information and other data information provided from the telephone module, callers' phone numbers and history, memos or messages connected with the callers' phone numbers, count of calls and an amount of time answering calls, personal information of callers, and a function for rejecting calls from unwanted callers.

15. The method of claim 14, wherein the step of communication comprises:
notifying of the received incoming call signal through the display device;
searching the memory for caller information relating to the incoming call signal and displaying the information; and
enabling the user to make the call through the remote control and the telephone module, if a user determines to receive the call from the displayed caller information.

16. The method of claim 13, wherein the audio data is stored in the memory in a compressed format.

17. A call transmitting and receiving method for a display device comprising a remote control for transmitting and receiving audio data, telephone module, and a memory for storing caller information and multimedia information, the method comprising the steps of:
allowing a user to dial a phone number directly from the remote control, or generate an outgoing call using the caller information stored in the memory; and
allowing the user to converse through the remote control and the telephone module when the call is answered.

18. The method of claim 17, wherein the caller information contains data information provided from the telephone module, callers' phone numbers and history, memos or messages connected with the callers' phone numbers, count of calls and an amount of time answering calls, personal information of callers, and a function for rejecting calls from unwanted callers.
